(19) United States
(12) Patent Application Publication
(10) Pub. No.: US 2003/0107551 A1
(43) Pub. Date: Jun. 12, 2003

(54) Tilt input device

(76) Inventor: Garrett Storm Dunker, Phoenix, AZ (US)

Correspondence Address: SEVENTH DAY SKYSTORM, PMB 546, 4802 E. RAY RD. SUITE 23, PHOENIX, AZ, 85044, US

(21) Appl. No.: 09/683,293

(22) Filed: Dec. 10, 2001

(51) Int. Cl. G09G 5/08

(52) U.S. Cl. 345/158

(57) ABSTRACT

The invention herein is an input device for a graphic display, where cursor movements are controlled using pitch and roll rotations of the device by the user. Pitch rotational input corresponds to cursor movement along the vertical Y axis of the graphic display, and roll rotational input corresponds to cursor movement along the horizontal X axis. The top side and bottom side of the housing are cubic curved to allow for comfort to the user and ease of rotating device. The device of the invention can operate on all surfaces and in freespace. The invention includes angular displacement sensing methods for two types of technologies in common use, rotary encoder sensors and optical position tracking sensors. One embodiment of the invention allows the user to select the asis vertical axis from which the sensors will measure angular displacement. This feature will allow the device to be operated at multiple angles; traditionally, as on a desktop surface in the horizontal plane, and at custom positions, such as holding the device angled down by one's side or with their arms crossed.

### BACKGROUND OF INVENTION

Common single handed input devices fall into the following categories; flat mice with roller balls and rotary encoders, trackballs with rotary encoders, optical flat mice, optical trackballs, and cordless versions of the above. These input devices translate natural hand motions into computer navigation commands.

Flat mice require a flat surface on which to operate, where the surface is free of obstacles and is several times larger than the mouse itself. These mice often need to repeatedly travel, be picked up, and travel again in the same direction in order to reach distant locations on a graphic display screen. Additionally, flat mice with roller balls accumulate dust and particulates. The motion transducers in contact with the roller ball lose friction, and consequently, the mice malfunction from time to time. Trackballs have the disadvantage of requiring repetitive rolling, whereat the motion that the thumb or fingers make is repeated to arrive at the desired location on the graphic display.

A solution to the above mentioned shortfalls is a mouse that relies on the pitch and roll motions of the users hand. This technique can allow for all moving parts to be enclosed within the mouse exterior and thus protected from dust and grit, the typical causes of malfunctions. The act of the repetitive rolling motion is replaced by the user maintaining an angular displacement from the corresponding measurement axis.

One case of which, as shown in U.S. Pat. No. 5,898,421, issued to Quinn, uses gyroscopic methods as a means of dictating cursor movement. This device optimizes a motor used to spin a gyroscopic element located in the core of a spherical pendulum, which, in turn, is held by a pair of gimbals having rotational freedom in the pitch and yaw directions. Angular rotations are measured with electro-optic shaft angle encoders on the surfaces of the pendulum and gimbals. The motor and corresponding power consumption would not be efficient in wireless applications, where energy is typically dependent from a battery power source. The housing thickness of this device must be greater than the sphere holding the motor. This invention would require a substantial device thickness, and, as a result, could not be implemented in conjunction with the common shape of that resembling a bar of bath soap. The corresponding height raised from the desktop would be larger than is comfortable if the arm were also resting on the desktop.

U.S. Pat. No. 6,130,664, issued to Suzuki, is direction specific to pitch and yaw and is designed for beginner's ease of use. This design requires an alignment method in combination with the gyroscope to keep a heading. The concept being that the mouse points, as if a laser, to where the user desires the cursor to move on the actual graphical display in front of the user.

U.S. Pat. No. 5,363,120 issued to Drumm operates on pitch and roll inputs and uses a hollow sphere containing two fluid media of different masses and a difference in angle refraction of light that passes through the boundary layer of the two mediums. This device is subject to waves, bubbles, leaks, and drying of liquid.

It is the object of the invention to obtain a versatile pitch and roll controlled input device that has minimal changes to traditional hardware, that is similar in shape and button location of traditional flat desktop mice, has practical power consumption properties, as needed for wireless versions, and finally, is without the complications of fluid waves and bubbles or drying and leaking of fluid.

### SUMMARY OF INVENTION

The invention is a device for controlling cursor position on a graphic display through rotational input in the pitch and roll directions by a user. Pitch rotations forward and backward of the device correspond to positive and negative movement, respectively, of the cursor on the Y axis of the display screen. Roll rotations to the right and left of the device correspond to positive and negative movement, respectively, of the cursor on the X axis of the display screen.

The act of maintaining an angular displacement from the basis vertical axis will translate into continued movement of the cursor across the display screen in the direction of the tilt. The speed that the cursor moves across the screen is proportional to the amount of angular displacement.

One unique feature of the invention is an embodiment that has the freedom of user assigned zero-ing capabilities. Whereby, when depressing a button, the basis vertical axis from which angular displacement measurements are taken is chosen. This allows the user to find and pick the most comfortable operating orientation, whether the user's arm is down by his side, on the tabletop in front of him, or with his arms crossed. A unique benefit is the ability for the user not to become sore or injured by operating the device in just one position over time, a characteristic of the prior art.

There is a limitation of the zero-ing feature in that when the basis vertical axis comes within near alignment, approximately 20 degrees, of the X or Y sensory spin axes of the device, the pendulum may no longer have rotational freedom, as the pendulum is now on it's side. This characteristic is dependent of the sensory apparatus system used. A set of 3 gimbals having rotational freedom in pitch, roll and yaw would not apply, however, the rotary encoder method would be hindered. This limitation does not inhibit normal use of the device.

The zero-ing calibration feature acts as a reset control and eliminates the need for recalibration in the event that sensing malfunctions occur from having been dropped, shaken, or otherwise disturbed.

The device, which can be operated while being hand held in freespace or traditionally, as on a desktop, is similar in shape to that of a conventional mouse with rollerball. The freespace version would operate most effectively for the user if the device were wireless. The housing of the devise has a cubic curved lower half for ease of rotating when on a surface, and an ergonomically curved upper half to be made comfortable for the users hand. The housing, however, has a flat, non-cubic curved, support area on the housing, which is aligned under the center of gravity on the lower surface. This is to serve as the resting position for the device when not in use. The curved underside need not be symmetric to allow for easy tilting for the user. By having the lower half made ergonomic to a left handed person and the upper half made ergonomic for a right handed, a fully ergonomic ambidextrous mouse can be achieved. In this case, two centered flat spots are necessary, located on both upper and lower half's. A simple external switch, a more complicated internal gravity sensor, or an option within the driver software could indicate to the device's circuitry whether a left or right handed user was using the device. The click buttons could be, in essence, along the equator such that flipping the device over would result in the same location of buttons and scroll wheel for an opposite handed person.

An object of the invention is to arrive at a method of dictating cursor control that is arguably more natural feeling than previous methods. The motion of pitch and roll rotation requires less user effort and motion than flat mice or trackballs to prescribe the motion of the cursor on the screen. The intensity of effort required, now decreased, in combination with the familiarity of the same handgrip and same hand-arm placement associated with a conventional mouse, gives the user a method of controlling cursor movement on a display screen that is easier than previous methods.

In one sensory system, a pair of conventional rotary encoders are used and are oriented orthogonal to each other, preferably in the X and Y axes. The rotary encoders shall maintain a vertical alignment orientation through the use of a pendulum mass. The mass is attached to the encoder via a spin shaft, where the shaft, weight, and rotary encoder units are free to rotate together.

The LED's and photo transducers associated with the rotary encoders' making and breaking of an electronic connection are fixed to the housing and are consequently rotated with the housing when user input is taking place. An electronic input controller unit interprets these signals as commands, which then control the cursor. The result of rotation in the form of pitch and roll is the movement of the phototransducers about the rotary encoders, which will, because of gravity, maintain their Z axes orientation.

Another sensory system uses a spherical pendulum mounted on a set of two gimbals and having rotational freedom in the pitch and roll directions. Optical sensing methods, based on the reflection of pixels within a scanned area, take place on the surface of the suspended spherical pendulum. Any rotational input by the user causes the reflection of the LED's to occur at a different location on the sphere. Pixels will be exiting one side of the scanned area while others enter on the opposite side.

The spherically shaped pendulum need not be entirely spherical; a portion of a sphere, hemisphere, or quarter sphere pendulum will be sufficient enough to provide enough detection surface for the non-ambidextrous version. For the left and right handed input device, an entirely spherical pendulum, having a mass positioned inside such that it will maintain the gravitational vector, will be necessary. The photo detector is located underneath the pendulum. Prior art detects angular displacement on the top of the sphere pendulum. By using the device with a partly spherical pendulum on a desktop and the location of the photodetector underneath, the thickness of the devise can be decreased significantly. These mechanics can be made small enough to fit in a housing similar in size to the typical mouse with rollerball.

### BRIEF DESCRIPTION OF DRAWINGS

FIG. 1 is an external perspective view of the housing of the invention.

FIG. 2 is an expanded perspective view of all components of the invention.

FIG. 3 is an expanded perspective view of the rotary encoders sensing method.

FIG. 4 is an expanded perspective view of the optical gimbals sensing method.

FIG. 5 is an illustration of the multiple positions in which the invention may be used.

FIG. 6 is an illustration of user operation of the invention.

FIG. 7 is an external perspective view of the left handed, right handed user switches for the ambidextrous version of the invention.

### DETAILED DESCRIPTION

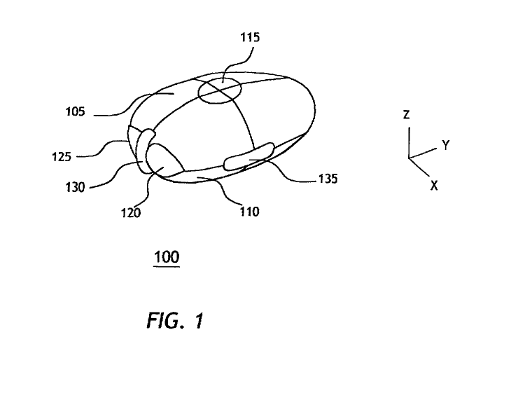

FIG. 1 shows an external perspective view of the device 100. This particular angle shows the invention device 100 when being used by a right handed person. This is distinguished by observing the presence of the zero-ing calibrator button 135; which would be depressed by the user's thumb. The zero-ing calibrator button 135 selects the basis vertical axis from which angular measurements are taken.

The housing is cubic curved on both top half 105 and bottom half 110. The halves are symmetric to each other and shaped such that top half 105 is comfortable and ergonomic to the right hand and bottom half 110 is comfortable and ergonomic to the left hand. In the center of the top half 105 there is a flat support surface 115, serving as the support surface of the housing that would be below the center of gravity when the device is rotated 180 degrees about the Y axes to be used by a left handed person. The flat support surface 115 of device 100 is the portion of the housing's surface that is in contact with the user's table, floor, or other supportive means, when not in use but oriented for the left handed user. FIG. 1 shows input buttons along the equator of the device. In the case where the device is used as a computer mouse for a right handed person, button 120 serves as the left click, typically the index finger, and button 125 serves as the right click, typically the middle finger. The scroll wheel 130 is located between the left click 120 and right click 125 buttons. If used for a left handed user, the device would be rotated 180 degrees about the Y axis and all buttons would still serve the same function. The scroll wheel, while still serving the same function will now, however, need to have the signal input inverted, along with the pitch rotation signal input.

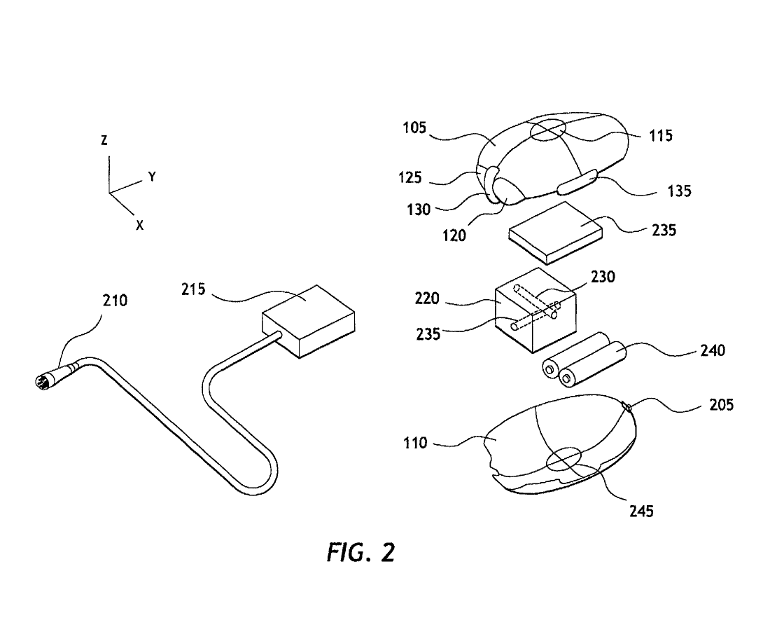

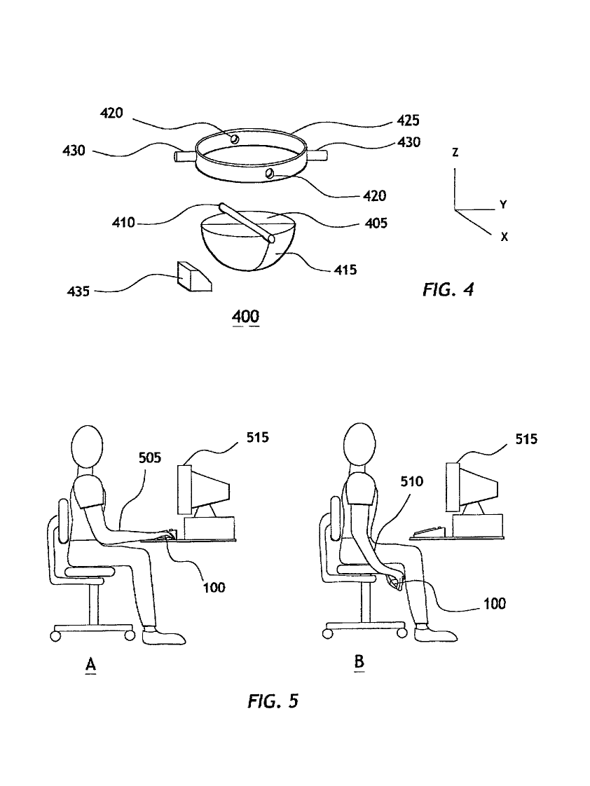

The device output commands from the scroll wheel 130 and the pitch angular displacement sensor 230 are inverted by toggling the left handed, right-handed user switch 205. The roll angular displacement sensor 225 will not be effected when switching from a left to right handed user or vice versa. The angular displacement sensor apparatus 220 consists of either two separate, but cooperative, detection methods, displacement sensors 225 and 230, or a single unified displacement detection method to be shown in FIG. 4. The electronic operations unit 235, which has an independent power source 240, represents the signal input/output information processor and a radio wave generator. The independent power source 240 is only necessary in the wireless version of device 100. The electrical operations unit 235 transmits the control signals via radio waves to the radio wave receiver 215, which in turn then relays the commands to a computer through PS2 port 210. The right-handed flat support surface 245 can be seen in FIG. 2 on the bottom half housing 110, and is located directly beneath the device's center of gravity.

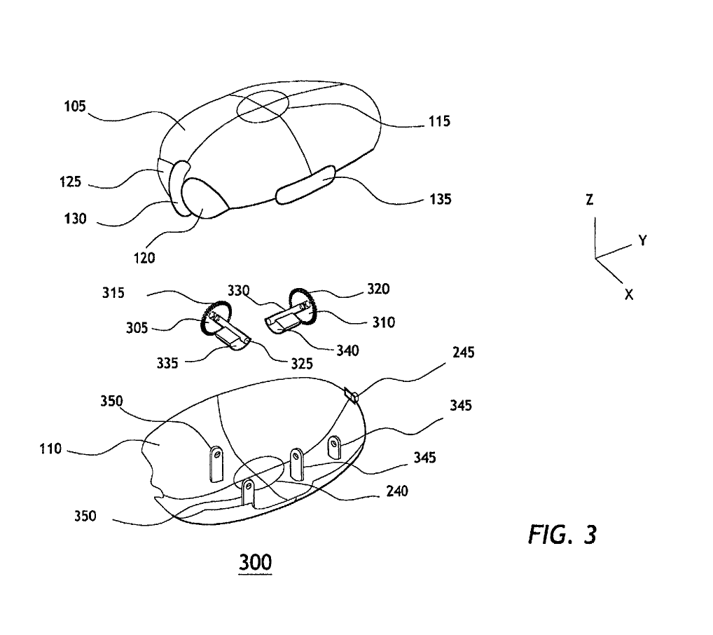

FIG. 3 shows the first sensing system 300, with two independent rotary encoders. The rotary encoder assemblies 305 and 310 are used to detect displacements of pitch and roll relative to a basis vertical axis. The assemblies 305 and 310 are located orthogonal to each other and preferably on the X and Y axes, respectively. The X axis rotary encoder slots 315 and the Y axis rotary encoder slots 320 make and break a light path that is interpreted by the electrical operations unit 235. The rotary encoder assemblies 305 and 310 are fixed on X and Y axes spin shafts, 325 and 330, respectively. The X axis pendulum mass 335 and the Y axis pendulum masses 340 are attached to their respective spin shafts 325 and 330, in order for the rotary encoders to maintain the gravitational vector. The rotary encoder assemblies 305 and 310 are free to rotate within the low friction X axis mounts 345 and Y axis mounts 350, respectively.

The second shown sensing system, sensing system 400 of FIG. 4, uses a spherically shaped pendulum 405 mounted on a gimbal frame 425 to achieve the rotational freedom in the pitch and roll directions. The spherically shaped pendulum 405 shown here is a hemisphere and is fixed to a pivot shaft 410, where the ends of the shaft serve as the inner gimbal. The surface 415 of the hemispherical pendulum 405 has distinguishable micro-texture detectable by optical sensor unit 435 as pixels. The ends of pivot shaft 410 mount in gimbal bearings 420 and are free to rotate about the X axis. The gimbal frame 425 has outer gimbals 430 protruding along the Y axis. These outer gimbals 430 are free to rotate about the Y axis in device housing mounts 345, FIG. 3. The housing mounts 350 from sensing system 300 would be removed for the application of sensing system 400.

FIG. 5 illustrates the benefits of the user assigned zero-ing calibrator button 135. Figure part 5A shows an individual using the invention device 100 as a mouse for a computer display 515 in the traditional operating position 505. Part 5B is the same individual operating the invention device 100 at an adjusted position 510. The individual needs only to press the zero-ing calibrator button 135, and then normal cursor control can resume. The invention device 100 is operable using both of the sensing methods, 300 and 400, at multiple positions desired by the individual.

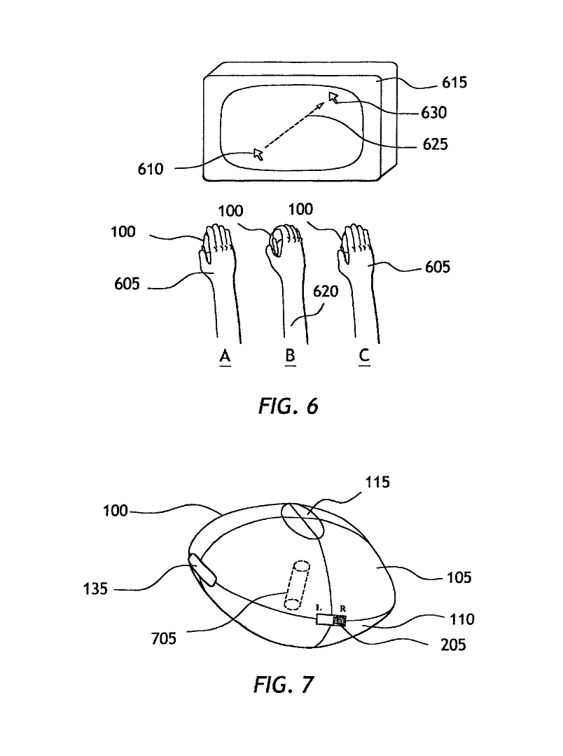

FIG. 6 illustrates the hand motions required by an individual to control a cursor on a graphic display screen 615. Hand orientation 605 and corresponding device 100 orientation are at the neutral input position; the chosen basis vertical axis of device 100 matches the gravitational vector. No pitch or roll displacements relative to the chosen vertical axis are present in hand orientation 605, part 6A, and the result is a stationary cursor 610 on graphic display screen 615. When the individual makes a change to hand position 620, to that of positive pitch and positive roll displacements, part 6B, the result is a moving cursor 625 up and to the right on the graphic display screen 615. Upon returning to hand position 605, part 6C, the result is a stationary cursor 630 at the desired location.

An alternative to having the exterior left handed, right handed user switch 205, and the software driver left handed, right handed option, is an internal gravity switch 705. FIG. 7 shows the internal gravity dependent switch 705. This switch would indicate to the electrical operations unit 235, which half of the device, 105 or 110, was oriented more towards the positive basis gravitational axis, and thus, which user, a left handed or right handed individual was using the device 100.

The scope of the invention is not limited to the embodiments or methods as detailed above. There are other methods of measuring angular displacement, such as inclinometers, laser gyroscopes, and others; wherein the method of doing so is not particular to the zero-ing calibrator feature. The improvement of making this device wireless, while beneficial, but not necessary, would require radio waves, infrared transmitters, or another method. The exact method of wireless transmission is not particular in this patent. All modifications and adaptations of the invention that fall into this contribution to the art are permitted as within the scope of this patent defined in the following claims.

What is claimed:

1. A handheld input device for controlling cursor operations on a graphic display comprising:
an outer housing having a cubic curved bottom half and a cubic curved top half;
a plurality of input buttons;a sensing apparatus with means of recognizing pitch and roll angular displacements relative to a basis vertical axis;
an electronic input processor coupled to said sensing apparatus and said graphic display that effects pitch rotational input into vertical movement of said cursor on said graphic display and effects roll rotational input into horizontal movement of said cursor on said graphic display.

2. A handheld input device as in claim 1, wherein one of the input buttons is a navigation scroll wheel.

3. A sensing apparatus system for measuring angular displacement for a device as in claim 1, comprising:
two rotary encoders, each fixed to a spin shaft, and arranged orthogonal to each other;
where one of said rotary encoders is free to rotate about the device X axis and the second of said rotary encoders is free to rotate about the device Y axis;
where said rotary encoders maintain a gravitational vector orientation through a pendulum action;
an LED and a corresponding photodetector for each of said rotary encoders units;
where said LED and said photodetector are positioned such that the rotary encoder passes through when rotated.

4. A sensing apparatus system for measuring angular displacement for device as in claim 1, comprising:
an optical position tracking sensor fixed to device housing;where said optical position tracking sensor is located on the bottom half of said device housing;
an optically reflective micro-texture surface located at a sufficient distance from said sensor such that movement of said surface will be registered by said sensor;
a spherically shaped pendulum;
where said optically reflective micro-texture surface is the outer surface of said spherically shaped pendulum;
where said spherically shaped pendulum can be a portion of or an entirety of a sphere;
a plurality of gimbals with rotational freedom in a minimum of 2 directions and coupled to said spherically shaped pendulum;
where said rotational directions are pitch and roll;
where said rotational directions are pitch, roll, and yaw.

5. An input device as in claim 1, comprising a user assigned basis vertical axis, from which angular displacement measurements are taken.

6. A signal inversion operation effectively inverting the output commands of pitch rotation for the ambidextrous version of the input device in claim 1, comprising:
a symmetry between the top half of the device housing and the bottom half;
where said top half is made ergonomic to a right-handed user and said bottom half made ergonomic to a left-handed user;
a switch indicative of a change between a left handed user and a right handed user;
where said switch is an external toggle switch;
where said switch is an internal gravity dependent switch.

7. A signal inversion operation effectively inverting the output commands of pitch rotation and the navigation scroll wheel for the ambidextrous version of the input device in claim 2, comprising:
a symmetry between the top half of the device housing and the bottom half;
where said top half is made ergonomic to a right handed user and said bottom half made ergonomic to a left handed user;
a switch indicative of a change between a left handed user and a right handed user;
where said switch is an external toggle switch;
where said switch is an internal gravity dependent switch.
